(19) United States
(12) Patent Application Publication
(10) Pub. No.: US 2016/0312074 A1
(43) Pub. Date: Oct. 27, 2016

(54) ELECTRICALLY CONDUCTIVE ADHESIVE TAPES AND ARTICLES THEREFROM

(71) Applicant: 3M INNOVATIVE PROPERTIES COMPANY, Saint Paul, MN (US)

(72) Inventors: Jeongwan Choi, Kyonggi-Do (KR); Jeffrey W. McCutcheon, Baldwin, WI (US)

(73) Assignee: 3M Innovative Properties Company, Saint Paul, MN (US)

(21) Appl. No.: 15/104,559

(22) PCT Filed: Dec. 16, 2014
(86) PCT No.: PCT/US2014/070437

§ 371 Date: Jun. 15, 2016

Related U.S. Application Data
(60) Provisional application No. 61/918,279, filed on Dec. 19, 2013.

(51) Int. Cl. C09J 7/02; C08K 3/08; H01B 1/02; B32B 7/12; H01B 5/02; C09J 9/02; B32B 5/18

(52) U.S. Cl. CPC C09J 7/0246; C09J 9/02; C08K 3/08; B32B 5/18; B32B 7/12; H01B 5/02; H01B 1/023; H01B 1/026; C09J 2433/00; C09J 2205/102; C08K 2003/0862; C09J 2467/006; B32B 2307/202; B32B 2405/00

(57) ABSTRACT

An electrically conductive, single-sided tape includes a conductive adhesive layer and a conductive polymeric layer positioned adjacent the conductive adhesive layer. The conductive adhesive layer includes a conductive, porous substrate having a plurality of passageways and an adhesive material positioned within at least a portion of the passageways. Optionally, the adhesive material may include a plurality of conductive particles dispersed within the adhesive material.

### TECHNICAL FIELD

The present invention is related generally to electrically conductive tapes. In particular, the present invention is a conductive single sided tape having a conductive adhesive layer, which includes a conductive porous substrate and a conductive polymeric layer.

### BACKGROUND

Electrically conductive tapes have numerous constructions and have conventionally been formed using various methods. For example, in one construction, an electrically conductive adhesive tape can be formed by dispersing finely divided silver in a pressure sensitive adhesive and coating the adhesive on an electrically conductive backing. In another construction, a conductive tape is formed with a monolayer of large conductive particles on the pressure sensitive adhesive. In yet another embodiment, an electrically conductive backing is embossed to have a plurality of closely spaced electrically conductive projections that extend almost through the layer of adhesive. One characteristic common to all of these constructions is that they do not provide reliable electrical connections to very small size contacts.

There is an increasing demand for thinner conductive single-sided tapes which provide reliable electrical connections to very small contacts. This is in part because connections to small contacts are becoming more important for many electronic uses of conductive tapes. Additionally, along with the thinner tapes, there is a need for improved handling and workability to facilitate the mass production required in the electronics industry. Currently, metal foil based tapes are one approach to providing the required conductivity and flexibility of the tape. However, the metal foil can be easily damaged during handling and rework. The foil tapes may also curl when the release liner is removed, making handling difficult. Thus, there is a need for thin, electrically conductive, single sided tapes that provide reliable electrical connections to very small contacts and that also provide good workability and handling characteristics.

### SUMMARY

In one embodiment, the present disclosure relates to an electrically conductive, single-sided tape including a conductive adhesive layer and a conductive polymeric layer positioned adjacent the conductive adhesive layer. The conductive adhesive layer includes a conductive, porous substrate having a plurality of passageways and an adhesive material positioned within at least a portion of the passageways. Optionally, the adhesive material may include a plurality of conductive particles dispersed within the adhesive material.

In another embodiment, the present invention is an electrically conductive, single-sided tape including a conductive nonwoven substrate, an adhesive embedded within the conductive nonwoven substrate and a conductive polymeric layer positioned adjacent the conductive nonwoven substrate. Optionally, the adhesive may include a plurality of metal particles dispersed within the adhesive.

### BRIEF DESCRIPTION OF THE DRAWINGS

FIG. 1A is a cross-sectional view of a first exemplary electrically conductive, single-sided tape of the present disclosure;

FIG. 1B is a schematic top plan view of a layer of electrically conductive, single-sided tape of FIG. 1A;

FIG. 2 is a cross-sectional view of a second exemplary electrically conductive, single-sided tape of the present disclosure;

FIG. 3 is a cross-sectional view of a third exemplary electrically conductive, single-sided tape of the present disclosure;

FIG. 4 is a schematic view of a test panel used for measuring the x-y axis electrical resistance of a conductive, single-sided tape; and

FIG. 5 is a schematic view of a test panel used for measuring the z-axis resistance of a conductive, single-sided tape.

These figures are not drawn to scale and are intended merely for illustrative purposes.

### DETAILED DESCRIPTION

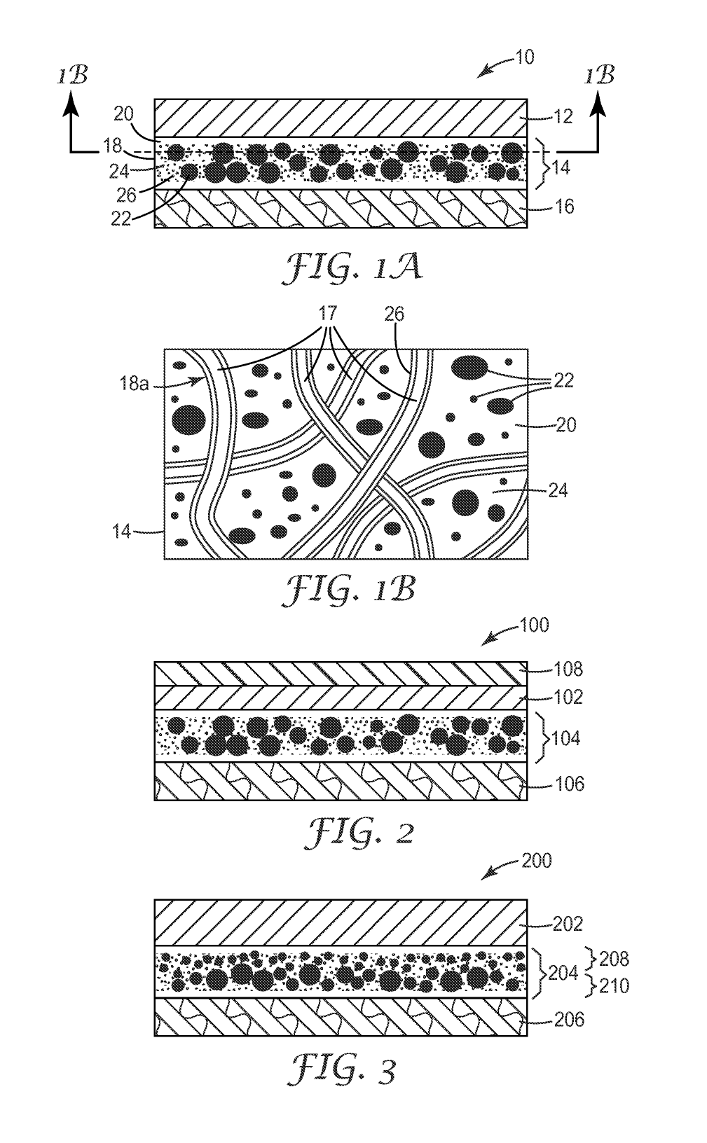

The electrically conductive, single sided tape of the present disclosure includes a polymeric layer and a conductive adhesive layer. In some embodiments, the polymeric layer is a conductive polymeric layer. FIG. 1A shows a cross-sectional view of a first embodiment of an electrically conductive, single-sided tape 10 including a conductive polymeric layer 12 and a conductive adhesive layer 14 on a release liner 16. Although a release liner is depicted in FIG. 1A, the electrically conductive, single-sided tape does not need to include a release liner. The conductive adhesive layer 14 is positioned between the conductive polymeric layer 12 and the release liner 16. Metal particles 22 may optionally be dispersed within the adhesive material 20. The electrically conductive, single-sided tape 10 of the present invention provides an adhesive layer that approaches volume-conductivity, results in reliable and excellent electrical performance for small size contacts and allows for good workability with less curling and/or wrinkling during tape assembly.

Conductive polymeric layer 12 includes one or more polymeric materials. Any polymeric material known in the art may be used, including but not limited to: thermoplastic, thermosets, thermoplastic elastomer, elastomers and ionomers. Examples of suitable polymeric materials include, but are not limited to: polyester, e.g., polyethylene terephthalate and polybutylene terephthalate; polycarbonate; polyamide e.g., nylon 6 and nylon 6,6, polyurethane; polyurea; polysulfones; acryclic, e.g., polymethylmethacrylate; polyethylene; polypropylene, silicone, phenolic, phenoxy, polyimide and the like. In one embodiment, the polymeric material is polyester. Polymer blends may also be used to form conductive polymeric layer 12. The conductive polymeric layer 12 may be a laminate of one or more conductive polymeric materials, e.g., a laminate comprising two or more conductive polymeric films. The polymers comprising the films may be the same or different. The polymeric material may be a conductive polymer. However, conductive polymers typically have higher modulus and stiffness. Subsequently, they may not have the desired handling characteristics compared to other polymeric materials.

In some embodiments, conductive polymeric layer 12 includes dispersed conductive particles, particularly when the polymeric material is considered non-conductive. Examples of suitable conductive particles include particles of metal, graphite and carbon black. Metal particles, include, but are not limited to: nickel, copper, tin, aluminum, silver, gold, silver coated copper, silver coated nickel, silver coated aluminum, silver coated tin, silver coated gold; nickel coated copper, nickel coated silver. In addition, non-conductive particles coated with a conductive layer may also be used. For example, metal coated: graphite, glass, ceramics, plastics, silica, elastomers, and mica. The metal used to coat the non-conductive particles includes, but is not limited to, the metals disclosed above. Also, combinations of these materials can be used in the present disclosure as the conductive particles. The conductive particles may be individual particles, i.e., primary particles, or aggregates of the individual particles that form aggregate particles or filamentary (chain-like) structures. The conductive particles may have a mean primary particle size in the range of about 0.5 to 100 microns, particularly from about 1 to 50 microns and more particularly from about 2 to 20 microns. The shape of the primary particles is generally spheroid, but flakes and other higher aspect ratio particles may be used. The aspect ratio of the primary particles may be between about 1 and about 50, between about 1 and about 20 or even between about 1 and about 10. In some embodiments, the primary particles having a spheroid shape may have an aspect ratio between about 1 and about 3, between 1 and about 2 or even between about 1 and about 1.5. In one embodiment, the conductive particles of conductive polymeric layer 12 include nickel. An example of suitable, commercially available nickel particle includes, but is not limited to, high purity nickel powder with a fine, three dimensional, filamentary structure, available under the trade designation FILAMENTARY NICKLE POWDER TYPE 255 from Novamet Specialty Products Corporation, Wyckoff, N.J.

The amount of conductive particles in the conductive polymeric layer 12 is selected based on particle type, shape and conductivity. The amount of conductive particles needs to be high enough to provide the desired level of conductivity, while being low enough to enable formation of the conductive polymeric layer 12 and to yield appropriate handling characteristics of the electrically conductive, single-sided tape 10. In one embodiment, the conductive polymeric layer includes between about 5 and about 90% conductive particles, particularly between about 15 and about 75% conductive particles and more particularly between about 20 and about 60% conductive particles by weight.

The conductive particle included in the conductive polymeric layer may be dispersed in the polymeric material by any known mixing techniques, including melt blending and solvent blending. For example, the conductive particle may be added to the polymeric material by conventional melt mixing via a batch or continuous process, e.g., single screw or twin screw extrusion, followed by the extrusion through an appropriate die to form a conductive polymeric layer. The conductive particle may be added to the polymeric material by dissolving or dispersing one or more polymeric materials in a suitable solvent(s), adding the desired amount of conductive particle to the solution, and mixing the solution. A conductive polymeric layer can then be produced by coating the solution on a backing or release liner and removing the solvent(s), typically through evaporation via a heating step. For example, the conductive particle may be added to, for example, a thermoplastic polyester resin having a number average molecular weight of about 28,000 g/mol and a softening point of about 105° C. dispersed in an organic solvent (available under the trade designation SKYBON ES300 from SK Chemicals, Seongnam-si, Gyeonggi-do, Korea) and/or a thermoplastic polyester resin having a number average molecular weight of about 21,000 g/mol and a softening point of about 140° C. dispersed in an organic solvent (available under the trade designation SKYBON ES100 from SK Chemicals). The polymer solution, with conductive particles, may be coated on a release liner and the solvent removed, e.g., through heating, yielding a conductive polymer film. In some embodiments, the polymeric layer is typically in the form of a film, having a thickness of greater than about 3 microns, greater than about 10 microns or even greater than about 20 microns and less than about 100 microns, less than about 50 microns or even less than about 30 microns.

When the polymeric layer is a conductive polymeric layer, the electrically conductive, single-sided tape 10 has z-axis conductivity through the entire thickness of the single sided tape and x-y-axis conductivity, i.e., x-y-z-axis conductivity. As discussed herein, the direction substantially perpendicular to at least one major surface of the tape, i.e., through the thickness of the single sided tape, is referred to as the z-axis direction. Two arbitrary orthogonal directions in a plane substantially parallel to at least one major surface of the single sided tape is referred to as the x-y-axis direction. In some embodiments, the x-axis direction corresponds to the length of the tape and the y-axis direction corresponds to the width of the tape.

The conductive adhesive layer 14 provides good electrical performance and handling. The conductive adhesive layer 14 includes a conductive porous substrate 18 and an adhesive material 20 positioned within pores or passageways 24 of the conductive porous substrate 18. Use of the term “passageways” throughout the specification will refer to pores or passageways. Any porous substrate having passageways and capable of being made conductive, e.g., through metallization of a non-conductive material, may be used as the conductive porous substrate. Examples of suitable non-conductive porous substrates which may be made conductive include, but are not limited to: woven or nonwoven fabrics, porous membranes and foams. The woven or nonwoven fabrics, porous membranes and foams are typically formed from polymeric materials including, but not limited to: polyester, e.g., polyethylene terephthalate (PET), nylon, polyurethane, vinylon, acrylic and cellulosic polymer, e.g., rayon. An example of a commercially available conductive, nonwoven includes a 28 micron thick polyester, nonwoven scrim coated with multiple, thin layers of metal, nickel/copper/nickel, available under the trade designation PNW-30-PCN from Ajin-Electron Co., Ltd., Busan, Korea. A metal or carbon fiber based woven or non-woven material may also be employed as the conductive porous substrate including, for example, a conductive mesh available under the trade designation SUI-2790YCL from Seiren, Osaka, Japan.

FIG. 1B shows a schematic top plan view of the conductive adhesive layer 14, wherein the conductive porous substrate 18 (FIG. 1A) of the conductive adhesive layer 14 includes a conductive nonwoven substrate 18a, which is formed by a non-conductive nonwoven web 17 (illustrated as a plurality of fibers 17) that has been coated with a conductive coating 26. The conductive coating can be disposed on the surface of fibers and in some embodiments, penetrate into the fiber. Adhesive material 20 containing optional metal particles 22 is disposed in the passageways or pores 24 of the conductive nonwoven substrate 18a. If open cell foam is used as the conductive porous substrate 18, the cell walls of the foam and/or exterior surfaces may be metalized.

In some embodiments, the conductive porous substrate includes conductive fibers, e.g., woven or nonwoven fabrics that include conductive fibers. In these embodiments, a portion of the conductive fibers may protrude above at least one major surface of the conductive adhesive layer 14, to facilitate electrical conduction through the thickness of the tape. The protruding fibers can make electrical contact with, for example, the conductive polymeric layer 12, thus facilitating z-axis conductivity. In some embodiments, a portion of the conductive fibers may protrude above both major surfaces of the conductive adhesive layer 14, facilitating electrical conduction between any substrate the tape is attached to (via the lower surface of the conductive adhesive layer 14) through to the top surface of the conductive polymeric layer 12. Having protruding fibers is not required to obtain acceptable z-axis conductivity. However, it is believed that having protruding fibers enhances the electrical connection and improves z-axis conductivity. In some embodiments, conductive adhesive layer 14 exhibits x-y-z-axis conductivity.

When the conductive porous substrate 18 includes a non-conductive material that has been made conductive by forming a conductive coating on its surface, the conductive coating can be a conductive metal, including, for example: copper, nickel, silver, gold, tin, cobalt, chromium, aluminum or any combination thereof. In one embodiment, a conductive nonwoven substrate 18a includes a conductive coating of copper and a corrosion resistant layer of nickel, silver or tin. One suitable example of a conductive nonwoven substrate is Ni/Cu/Ni/PET. In one embodiment, the conductive porous substrate 18 is between about 5 and about 100 μm thick, particularly between about 10 and about 80 μm thick and more particularly between about 20 and about 50 μm thick.

The adhesive material 20 fills at least a portion of the passageways 24 of the conductive porous substrate 18, resulting in improved cohesion in the conductive adhesive layer 14. In one embodiment, the adhesive material 20 substantially fills the entirety of the passageways. However, due to small bubbles that may become trapped in the conductive porous substrate 18 during fabrication, the adhesive material 20 may not fill 100% of the volume of the passageways, creating voids in the conductive porous substrate. In one embodiment, the passageways are filled with the adhesive material 20 such that the conductive porous substrate 18 includes less than about 10% voids, particularly less than about 5% voids, and more particularly less than about 2% voids by volume, based on total volume of the passageways in the conductive porous substrate.

Various manufacturing methods can be employed to form the conductive adhesive layer 14 including, but not limited to: lamination of a transfer adhesive to one or both sides of the appropriate conductive porous substrate; imbibing an adhesive solution, i.e., an adhesive contained in solvent, into at least some of the pores/passageways of the conductive porous substrate followed by solvent removal and optional curing; or imbibing a substantially 100% solids adhesive precursor solution, comprising monomers, oligomers and/or dissolved polymers, into the pores/passageways of the conductive porous substrate followed by curing of the adhesive precursor solution to form an adhesive. The imbibing method, i.e., allowing a liquid to flow into at least some of the pores/passageways of the conductive porous substrate, can be accomplished by any known methods including dip coating, spray coating, knife coating, notch bar coating, roll coating and the like.

The method used to fabricate the conductive adhesive layer 14 can affect the resulting structure of the conductive adhesive layer 14. When using a lamination technique to laminate a transfer adhesive to the conductive porous substrate 18, the adhesive material 20 may be in the passageways 24 at or near the surface of one or both sides of the conductive porous substrate 18. The depth of penetration of the adhesive material 20 into the pores/passageways 24 of the conductive porous substrate 18 is dependent on the pressure applied during lamination, the flow properties of the transfer adhesive and properties of the conductive porous substrate 18 such as, for example, the pore size and thickness of the conductive porous substrate 18. To facilitate penetration of the adhesive into the conductive porous substrate, the conductive porous substrate/adhesive laminate may be annealed at elevated temperatures. In one embodiment, the conductive porous substrate/adhesive laminate is annealed at between about 30° C. and about 100° C. Under appropriate conditions, the adhesive material 20 may be able to penetrate the entire depth of the conductive porous substrate 18. In another embodiment, when using an imbibing method, adhesive material 20 may at least partially fill at least some of the pores/passageways 24 of the conductive porous substrate 18. Thus, depending on the method used to fabricate the conductive adhesive layer 14, adhesive material 20 may penetrate the entire thickness of the conductive porous substrate 18 as well as be deposited as a layer on the surfaces of the conductive porous substrate 18 adjacent to conductive polymeric layer 12 and release liner 16, as shown in FIGS. 1A, 1B, 2 and 3. In some embodiments, the adhesive material 20 may not penetrate the entire depth of the conductive porous substrate 18 and/or may not extend outside the surfaces of the conductive porous substrate 18.

In some embodiments, the adhesive material 20 is non-conductive and z-axis conductivity may be obtained via the conductive porous substrate 18. In this embodiment, electrical connection may be enhanced if the conductive porous substrate 18 includes conductive fibers that protrude above one or both major surfaces of the conductive adhesive layer 14. Also, during the end use application, appropriate pressure may be applied to the tape, regardless of whether or not the adhesive material 20 is conductive or non-conductive, enhancing electrical connection between the conductive porous substrate 18 and the conductive polymeric layer 12 and/or enhancing electrical connection between the conductive porous substrate 18 and any substrate the tape is attached to (via the lower surface of the conductive adhesive layer 14).

In one embodiment, the adhesive material 20 is a pressure sensitive adhesive (PSA) material. To achieve PSA characteristics, the polymer(s) used for the adhesive can be tailored to have a resultant glass transition temperature (Tg) of less than about 0° C. Examples of suitable PSA materials include, but are not limited to: rubber-based PSAs, silicone based PSAs and acrylic based PSAs. Particularly suitable pressure sensitive adhesive are (meth)acrylate copolymers. Such copolymers typically are derived from monomers comprising about 40% by weight to about 98% by weight, often at least about 70% by weight, or at least about 85% by weight, or even at least about 90% by weight, of at least one alkyl (meth)acrylate monomer that, as a homopolymer, has a Tg of less than about 0° C.

Examples of such alkyl (meth)acrylate monomers are those in which the alkyl groups comprise from about 4 carbon atoms to about 14 carbon atoms and include, but are not limited to, n-butyl acrylate, 2-ethylhexyl acrylate, isooctyl acrylate, isononyl acrylate, isodecyl acrylate, and mixtures thereof. Optionally, other vinyl monomers and alkyl (meth)acrylate monomers which, as homopolymers, have a Tg greater than 0° C., such as methyl acrylate, methyl methacrylate, isobornyl acrylate, vinyl acetate, styrene, and the like, may be utilized in conjunction with one or more of the low Tg alkyl (meth)acrylate monomers and copolymerizable polar monomers, including, but not limited to, basic and/or acidic monomers, provided that the Tg of the resultant (meth)acrylate copolymer is less than about 0° C.

The PSA may include from about 3% by weight to about 35% by weight of a hydrophilic, hydroxyl functional monomeric compound, based upon the total weight of monomers comprising the PSA. The hydrophilic, hydroxyl functional monomeric compound may have a hydroxyl equivalent weight of less than 400. The hydroxyl equivalent molecular weight is defined as the molecular weight of the monomeric compound divided by the number of hydroxyl groups in the monomeric compound. Useful monomers include 2-hydroxyethyl acrylate and methacrylate, 3-hydroxypropyl acrylate and methacrylate, 4-hydroxybutyl acrylate and methacrylate, 2-hydroxyethylacrylamide, and N-hydroxypropylacrylamide. Additionally, hydroxy functional monomers based on glycols derived from ethylenoxide or propyleneoxide can also be used. An example of this type of monomer includes a hydroxyl terminated polypropylene glycol acrylate, available as BISOMER PPA 6 from Cognis, Germany. Diols and triols are also contemplated for the hydrophilic monomeric compound. They may also have a hydroxyl equivalent weights of less than 400.

In some embodiments, the PSA may include one or more polar monomers, such as a copolymerizable polar monomer. The polar monomer may be basic or acidic. Basic monomers that may be incorporated into the PSA may comprise from about 2% by weight to about 50% by weight, or about 5% by weight to about 30% by weight, based upon the total weight of monomers comprising the PSA. Exemplary basic monomers include, but are not limited to, N,N-dimethylaminopropyl methacrylamide (DMAPMAm); N,N-diethylaminopropyl methacrylamide (DEAPMAm); N,N-dimethylaminoethyl acrylate (DMAEA); N,N-diethylaminoethyl acrylate (DEAEA); N,N-dimethylaminopropyl acrylate (DMAPA); N,N-diethylaminopropyl acrylate (DEAPA); N,N-dimethylaminoethyl methacrylate (DMAEMA); N,N-diethylaminoethyl methacrylate (DEAEMA); N,N-dimethylaminoethyl acrylamide (DMAEAm); N,N-dimethylaminoethyl methacrylamide (DMAEMAm); N,N-diethylaminoethyl acrylamide (DEAEAm); N,N-diethylaminoethyl methacrylamide (DEAEMAm); N,N-dimethylaminoethyl vinyl ether (DMAEVE); N,N-diethylaminoethyl vinyl ether (DEAEVE); and mixtures thereof. Other useful basic monomers include vinylpyridine, vinylimidazole, tertiary amino-functionalized styrene (e.g., 4-(N,N-dimethylamino)-styrene (DMAS), 4-(N,N-diethylamino)-styrene (DEAS)), N-vinylpyrrolidone, N-vinylcaprolactam, acrylonitrile, N-vinylformamide, (meth)acrylamide, and mixtures thereof.

Acidic monomers that may be incorporated into the PSA may comprise from about 2% by weight to about 30% by weight of the PSA, or about 2% by weight to about 15% by weight, based upon the total weight of monomers comprising the PSA. Useful acidic monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, beta-carboxyethyl acrylate, 2-sulfoethyl methacrylate, styrenesulfonic acid, 2-acrylamido-2-methylpropanesulfonic acid, vinylphosphonic acid, and the like, and mixtures thereof. Due to their availability, typically ethylenically unsaturated carboxylic acids are used.

The adhesive material 20 may be made in-situ during the manufacture of the electrically conductive, single-sided tape or it can be previously made and be in the form, for example, of a polymeric solution, which includes an appropriate solvent for the adhesive material 20. One useful polymeric solution is an acrylic copolymer solution, 59% solids, available under the trade designation SEN-7000 from Geomyung Corp., Cheon-an, Korea.

The pressure sensitive adhesive can be inherently tacky. If desired, tackifiers can be added to the PSA or the adhesive precursor solution before formation of the pressure sensitive adhesive. In one embodiment, the PSA or adhesive precursor solution includes up to about 30% tackifier, or up to about 50% tackifier by weight. Useful tackifiers include, for example, rosin ester resins, aromatic hydrocarbon resins, aliphatic hydrocarbon resins, and terpene resins. In general, light-colored tackifiers selected from hydrogenated rosin esters, terpenes, or aromatic hydrocarbon resins can be used.

Other materials can be added for special purposes, including, for example, fillers, oils, plasticizers, antioxidants, UV stabilizers, pigments, curing agents and polymer additives. Exemplary fillers include, but are not limited to a heat conductive filler, a flame resistant filler, an anti-static agent, a foaming agent, polymeric microspheres and viscosity modifiers, including fumed silica, such as AEROSIL R 972 from Evonik Industries, Essen, Germany.

The adhesive material may have additional components added to the adhesive precursor solution. For example, the mixture may include a multifunctional crosslinker. Such crosslinkers include thermal crosslinkers which are activated during the drying step of preparing solvent coated adhesives and crosslinkers that copolymerize during the polymerization step. Such thermal crosslinkers may include multifunctional isocyanates, aziridines, multifunctional (meth)acrylates, and epoxy compounds. Exemplary crosslinkers include difunctional acrylates such as 1,6-hexanediol diacrylate or multifunctional acrylates such as are known to those of skill in the art. Useful isocyanate crosslinkers include, for example, an aromatic diisocyanate available as DESMODUR L-75 from Bayer, Cologne, Germany and GT75 from Geomyung Corporation, Cheon-an, Korea. Ultraviolet, or “UV”, activated crosslinkers can also be used to crosslink the pressure sensitive adhesive. Such UV crosslinkers may include benzophenones and 4-acryloxybenzophenones. Typically, the crosslinker, if present, is added to the adhesive precursor solutions in an amount of from about 0.05 parts by weight to about 5.00 parts by weight, based upon the total weight of monomers comprising the PSA.

In addition, the adhesive precursor solutions for the provided adhesive materials can include a thermal or a photoinitiator. Examples of thermal initiators include peroxides such as benzoyl peroxide and its derivatives or azo compounds such as VAZO 67, available from E. I. du Pont de Nemours and Co. Wilmington, Del., which is 2,2′-azobis-(2-methylbutyronitrile), or V-601, available from Wako Specialty Chemicals, Richmond, Va., which is dimethyl-2,2′-azobisisobutyrate. A variety of peroxide or azo compounds are available that can be used to initiate thermal polymerization at a wide variety of temperatures. The adhesive precursor solutions can include a photoinitiator. Particularly useful are initiators such as IRGACURE 651, available from BASF Corporation, Florham Park, N.J., which is 2,2-dimethoxy-2-phenylacetophenone. The initiators are typically added to the adhesive precursor solutions in the amount of from about 0.05 parts by weight to about 2 parts by weight, based upon the total weight of monomers comprising the PSA.

In other embodiments, the adhesive material 20 may be a thermosetting adhesive material. More specifically, an adhesive material that can be B-staged (a B-stageable material) may be used. Ultraviolet (UV) B-staging is preferred. In this approach, a dual cure adhesive composition is employed. The first cure is initiated by UV or another light source which initiates a curing reaction to thicken the composition prior to final curing. The final curing may be conducted using a thermal curing system. The adhesive composition contains UV curable monomers and/or oligomers which are mixed with thermally curable monomers and or oligomers. In addition, the corresponding initiators and/or curing agents for both curing mechanisms will be added to the adhesive mixture. After thorough mixing, the adhesive composition is coated on at least one release liner and may be coated between two release liners. During this coating process, a conductive non-woven may be simultaneously embedded in the adhesive coating. The coated composition is then exposed to UV radiation to at least partially cure the UV curable components of the composition. At this stage, the composition may still have a sufficient amount of tack to enable it to be a pressure sensitive adhesive.

The UV curable monomomers and initiators may be those previously described herein. The thermosetting monomers and/or oligomers of the adhesive composition may be epoxy and phenoxy based materials. Other thermosetting resins include urethane and phenolic based materials. In addition, one or more appropriate crosslinkers, curatives and/or accelerators may be added to the adhesive composition. For example, for an epoxy, a crosslinkers such as a dicyandiamide may be used. A preferred dicyandiamide is available under the trade designation Dicyanex 1400B from Air Products and Chemicals, Inc., Allentown, Pa. Accelerators may also be added, a preferred accelerator for an epoxy being a urea-based accelerator, e.g., a urea based accelerator available under the trade designation Amicure UR from Air Products and Chemicals, Inc.

The adhesive material 20 may be a conductive adhesive material. In one embodiment, the adhesive material 20 includes the metal particles 22. The metal particles 22 are dispersed in the adhesive material 20, which is then embedded into the conductive porous substrate 18. Examples of suitable metal particles include, but are not limited to: nickel, copper, tin, aluminum, silver, gold, silver coated copper, silver coated nickel, silver coated aluminum, silver coated tin, silver coated gold; nickel coated copper, nickel coated silver; silver coated or nickel coated: graphite, glass, ceramics, plastics, silica, elastomers, and mica. Also, combinations of these materials can be used in the present disclosure as the metal particles. In one embodiment, the metal particles 22 dispersed in the adhesive material 20 include nickel. An example of suitable, commercially available nickel includes, but is not limited to, T123 from Inco, Vale Canada Limited, Toronto, Canada. The shape of the particles is generally spheroid, but flakes and other higher aspect ratio particles may be used. The aspect ratio may be between about 1 and about 50, between about 1 and about 20 or even between about 1 and about 10. In some embodiments, particles having a spheroid shape may have an aspect ratio between about 1 and about 3, between 1 and about 2 or even between about 1 and about 1.5. In one embodiment, the adhesive material 20 includes between about 1 and about 70% metal particles, particularly between about 2 and about 60% metal particles and more particularly between about 3 and about 50% metal particles by weight. The metal particles have a mean particle size in the range of about 0.5 to 100 microns, particularly from about 1 to 50 microns and more particularly from about 2 to 20 microns.

The conductive adhesive layer 14 can be laminated onto various conductive polymeric layers to form a single-sided tape structure. The conductive polymeric layer 12 provides improved physical properties, handling characteristics and electromagnetic interference (EMI) shielding.

In one embodiment, the electrically conductive, single-sided tape 10 (without optional release liner 16) is between about 15 um and about 150 μm thick, particularly between about 25 and about 125 μm thick and more particularly between about 30 and about 100 μm thick.

The release liner 16 is positioned along a surface of the conductive adhesive layer 14 and protects the conductive adhesive layer 14 from dust and debris until ready for use. Examples of suitable release liners include but are not limited to, PET release liners and paper release liners.

FIG. 2 shows a cross-sectional view of a second embodiment of an electrically conductive, single-sided tape 100 including a conductive polymeric layer 102 and a conductive adhesive layer 104 on an optional release liner 106. The second embodiment of the electrically conductive, single-sided tape 100 is similar in construction and function to the first embodiment of the conductive, single-sided tape 10 except that the second embodiment of the electrically conductive, single-sided tape 100 includes a polymeric film 108 positioned on the conductive polymeric layer 102 opposite the conductive adhesive layer 104.

The polymeric film 108 is one of various general tape structures and functions to increase the tensile strength of the electrically conductive, single-sided tape 100 and/or to insulate the z-axis of the conductive, single-sided tape 100 and/or to protect the conductive polymeric layer 102 from corrosion and physical damage. In one embodiment, the polymeric film 108 is formed directly onto the conductive polymeric layer 102. In another embodiment, the polymeric film is laminated with an adhesive. Exemplary polymeric films include, but are not limited to, non-conductive films. In one embodiment, the polymeric film 108 is a black, colored PET film. In one embodiment, the polymeric film 108 has a thickness of between about 2.5 and about 20 microns, particularly between about 1 and about 15 microns and more particularly between about 1.5 microns and about 5 microns. A very thin metal layer can be directly plated onto polymeric film 108, for example, by metal evaporation and sputtering. Exemplary plated metals include gold, silver and other metals.

FIG. 3 shows a cross-sectional view of a third embodiment of an electrically conductive, single-sided tape 200 including a conductive polymeric layer 202 and a conductive adhesive layer 204 on an optional release liner 206. The third embodiment of the electrically conductive, single-sided tape 200 is similar in construction and function to the first embodiment of the conductive, single-sided tape 10 except that the third embodiment of the conductive, single-sided tape 200 includes a first adhesive layer 208 and a second adhesive layer 210 within conductive adhesive layer 204.

First and second adhesive layers 208 and 210 may include particles. The first and second adhesive layers 208 and 210 may include the same particle types or may include different particle types. In one embodiment, both the first and second adhesive layers 208 and 210 include the same particle type. For example, both the first and second adhesive layers 208 and 210 may include nickel particles. In another embodiment, the first and the second adhesive layers 208 and 210 include different particle types. For example, the first adhesive layer 208 may include nickel particles while the second adhesive layer 210 includes silver particles. In addition, the first and second adhesive layers 208 and 210 may include the same number of particle types or may include a different number of particle types. In one embodiment, both the first and second adhesive layers 208 and 210 include two particle types. In another embodiment, the first adhesive layer 208 includes only one particle type while the second adhesive layer 210 includes more than one particle type. For example, the first adhesive layer 208 may include only nickel particles while the second adhesive layer 210 includes silver and nickel particles. Any combination of particle types may be included in the first and second adhesive layers 208 and 210 without departing from the intended scope of the present invention.

The first and second adhesive layers may include any of the materials described for the adhesive material 20. In one embodiment, both the first and second adhesives layers 208 and 210 are acrylic based. The compositions of the acrylic copolymers of the first and second adhesive layers 208 and 210 may be the same or may be different.

One method of forming the electrically conductive, single-sided tape 10, 100, 200 of the present invention is by using a dual liner coating and UV curing process. The method includes preparing a syrup including an adhesive and a photoinitiator to form a prepolymer, imbibing the prepolymer in pores of a conductive porous substrate, passing the conductive porous substrate and prepolymer between a first and second liner, curing the prepolymer to form a conductive adhesive layer, e.g., a conductive porous substrate embedded pressure sensitive adhesive layer, removing the first liner from the conductive adhesive layer, and laminating the conductive adhesive layer onto a conductive polymeric layer, i.e., a conductive polymeric backing.

Another method of forming the electrically conductive, single-sided tape 10, 100, 200 of the present invention uses a single liner coating and thermal curing process. The method includes coating a polymer adhesive solution, for example an acrylic copolymer solution, onto the conductive porous substrate by directly imbibing the polymer adhesive solution into the pores or passageways of the conductive porous substrate, passing the polymer adhesive solution and the conductive porous substrate on a liner, drying and heat curing the polymer adhesive solution to form a conductive adhesive layer, e.g., a conductive porous substrate embedded pressure sensitive adhesive layer, and laminating the conductive adhesive layer on to a conductive polymeric layer, i.e., a conductive polymeric backing.

Another method of forming the conductive, single-sided tape 10, 100, 200 of the present invention includes using a single liner coating, thermal curing and transfer laminating process. The method includes coating a polymer adhesive solution, for examples an acrylic copolymer solution, onto a release liner, drying and heat curing the coated polymer adhesive solution on the liner and transferring the polymer adhesive layer on the liner onto both sides of the conductive porous substrate to form a conductive adhesive layer, e.g., a conductive porous substrate embedded pressure sensitive adhesive layer, with the adhesive positioned within at least a portion of the passageways of the conductive porous substrate, and laminating the conductive adhesive layer on to a conductive polymeric layer, i.e., a conductive polymeric backing.

Each method can be combined to form the conductive, single-sided tape 10, 100, 200 of the present invention. For example, in the third embodiment of the conductive, single-sided tape 200, the first and second adhesive layers 208 and 210 may be fabricated using the same process, or different processes. In one embodiment, one adhesive layer may be made from a solution coating process on a release liner and then laminated by a transfer process to the conductive porous substrate. The second adhesive layer may be made by an imbibing process, e.g., coating an adhesive solution directly onto the conductive porous substrate and then drying and optionally, curing.

Select embodiments of the present disclosure include, but are not limited to, the following:

In a first embodiment, the present disclosure provides an electrically conductive, single-sided tape comprising:

a conductive adhesive layer comprising:
a conductive porous substrate having a plurality of passageways; and
an adhesive material positioned within at least a portion of the passageways; and

a conductive polymeric layer positioned adjacent the conductive-adhesive layer.

In a second embodiment, the present disclosure provides an electrically conductive, single-sided tape according to the first embodiment, wherein the adhesive material is a conductive adhesive material.

In a third embodiment, the present disclosure provides an electrically conductive, single-sided tape according to the second embodiment, wherein the conductive adhesive material comprises metal particles.

In a forth embodiment, the present disclosure provides an electrically conductive, single-sided tape according to the third embodiment, wherein the metal particles comprise at least one of nickel, copper, tin, aluminum, silver, silver coated copper, silver coated nickel, silver coated aluminum, silver coated tin, silver coated gold, silver coated graphite, silver coated glass, silver coated ceramics, silver coated plastics, silver coated silica, silver coated elastomers, silver coated mica, nickel coated copper, nickel coated silver, nickel coated graphite, nickel coated glass, nickel coated ceramics, nickel coated plastics, nickel coated silica, nickel coated elastomers, nickel coated mica, and combinations thereof.

In a fifth embodiment, the present disclosure provides an electrically conductive, single-sided tape according to the first to forth embodiments, wherein the conductive porous substrate is a conductive nonwoven substrate.

In a sixth embodiment, the present disclosure provides an electrically conductive, single-sided tape according to the first to fifth embodiments, wherein the conductive porous substrate comprises conductive fibers.

In a seventh embodiment, the present disclosure provides an electrically conductive, single-sided tape according to the sixth embodiment, wherein a portion of the conductive fibers protrude from at least one major surface of the conductive adhesive layer.

In an eighth embodiment, the present disclosure provides an electrically conductive, single-sided tape according to the sixth embodiment, wherein a portion of the conductive fibers protrude from both major surfaces of the conductive adhesive layer.

In a ninth embodiment, the present disclosure provides an electrically conductive, single-sided tape according to the first to eighth embodiments, further comprising a polymeric film positioned adjacent the conductive polymeric layer.

In a tenth embodiment, the present disclosure provides an electrically conductive, single-sided tape according to the first to ninth embodiments, further comprising a release liner positioned adjacent the conductive adhesive layer.

In an eleventh embodiment, the present disclosure provides an electrically conductive, single-sided tape according to the first to tenth embodiments, wherein the conductive single-sided tape is between about 15 um and about 150 μm thick.

In a twelfth embodiment, the present disclosure provides an electrically conductive, single-sided tape according to the first to eleventh embodiments, wherein the conductive porous substrate includes a conductive coating.

In a thirteenth embodiment, the present disclosure provides an electrically conductive, single-sided tape according to the first to twelfth embodiments, wherein the adhesive material is a pressure sensitive adhesive material.

In a fourteenth embodiment, the present disclosure provides an electrically conductive, single-sided tape according to the first to thirteenth embodiments, wherein the adhesive material is an UV or thermally B-stageable adhesive material.

In a fifteenth embodiment, the present disclosure provides an electrically conductive, single-sided tape according to the first to fourteenth embodiments, further comprising at least one additional filler selected from the group consisting of a heat conductive filler, a flame resistant filler, an anti-static agent, a foaming agent, polymeric microspheres and viscosity modifiers.

In a sixteenth embodiment, the present disclosure provides an electrically conductive, single-sided tape according to the first to fifteenth embodiments, wherein the adhesive layer comprises a first adhesive layer and a second adhesive layer.

In a seventeenth embodiment, the present disclosure provides an electrically conductive, single-sided tape according to the sixteenth embodiment, wherein the first adhesive layer comprises one metal particle type.

In an eighteenth embodiment, the present disclosure provides an electrically conductive, single-sided tape according to the sixteenth or seventeenth embodiments, wherein the second adhesive layer comprises at least two metal particles types.

In a nineteenth embodiment, the present disclosure provides an electrically conductive, single-sided tape according to the first to eighteenth embodiments wherein the passageways are filled with adhesive material such that the conductive porous substrate includes less than about 10% voids by volume.

In a twentieth embodiment, the present disclosure provides an electrically conductive, single-sided tape according to the first to nineteenth embodiments wherein the passageways are filled with adhesive material such that the conductive porous substrate includes less than about 2% voids by volume.

In a twenty-first embodiment, the present disclosure provides an electrically conductive single-sided tape according to the first to twentieth embodiments, wherein the electrically conductive single sided tape exhibits x-y-axis conductivity and z-axis conductivity.

In a twenty-second embodiment, the present disclosure provides an electrically conductive single-sided tape according to the first to twenty-first embodiments, wherein the conductive adhesive layer exhibits x-y-z-axis conductivity.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following example are on a weight basis.

### Test Methods

### Electrical Resistance Test Method 1 (x-y Resistance)

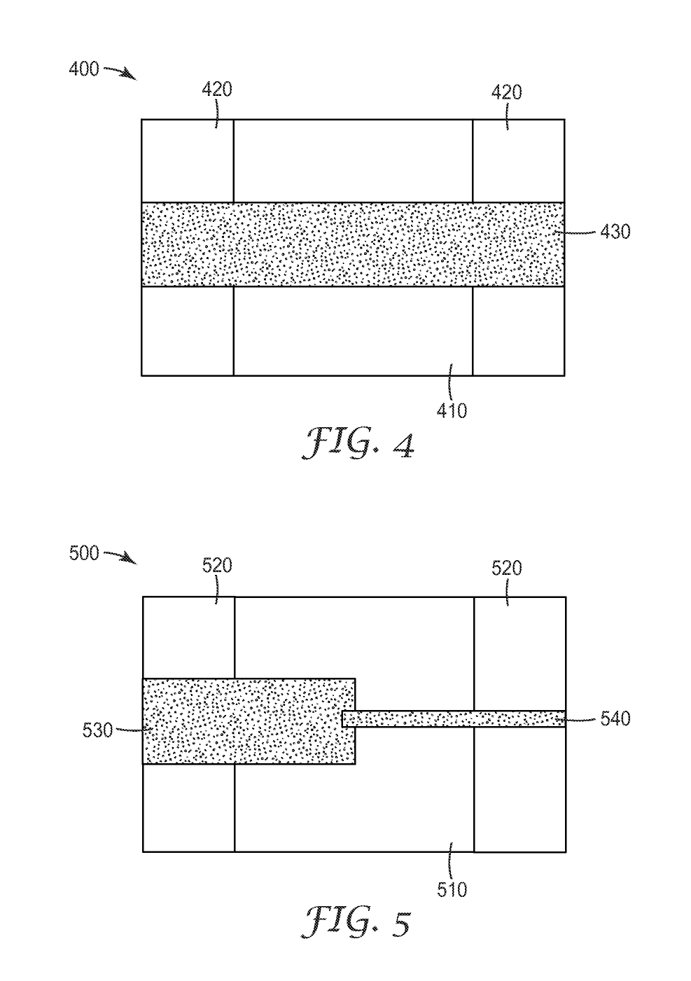

The electrical resistance of an electrically conductive single-sided tape was evaluated by measuring the electrical resistance between two copper foil tape strips that were in electrical communication via the conductive single sided tape. A test panel with Cu foil tapes was prepared as follows. Two strips of copper foil tape, each about 10 mm×30 mm, were laminated to a 50 mm×30 mm polymethymethacrylate plate. The Cu tape strips were applied along each 30 mm edge of the plastic plate. The distance between the two strips of Cu tape was about 30 mm. A piece of conductive single-sided tape, 50 mm×10 mm, with release liner removed, was then hand laminated to the plastic plate. The conductive single-sided tape was applied perpendicular to the Cu tape strips, such that the ends of the conductive single-sided tape overlapped with each of the strips of Cu tape, producing a 10 mm×10 mm region of overlap between each strip of Cu foil tape and the conductive single sided tape. After initial hand lamination, a 2 kg rubber roll was rolled across the conductive single sided tape, producing a test panel, FIG. 4. FIG. 4 shows test panel 400 with plastic plate 410, strips of Cu foil tape 420 applied to its surface and electrically conductive, single-sided tape 430. After 20 minutes of dwell time, the D.C. electrical resistance between the copper foil strips was measured using a Keithley 580 micro-ohmmeter available from Keithley Instruments Inc., Cleveland, Ohio by placing the ohmmeter leads in contact with the exposed surface of the Cu foil tape strips on either side of the plate. The electrical resistance was recorded 30 seconds after the leads of the micro-ohmmeter contacted the Cu foil tape strips of the test panel.

Electrical Resistance Test Method 2 (z-Axis Resistance)

The electrical resistance of an electrically conductive single-sided tape was evaluated by measuring the electrical resistance between two copper foil tape strips that were in electrical communication via the conductive single sided tape. A test panel with Cu foil tapes was prepared similarly to that disclosed in Electrical Resistance Test Method 1, except, two strips of conductive single-sided tape were used. A first strip was about 10 mm×25 mm, a second strip was about 2 mm×27 mm. After removing the release liner, the first strip was laminated to the test panel, perpendicular to the Cu foil tape, making contact with one of the Cu foil tape strips. A 2 kg rubber roll was rolled across the first strip of conductive single sided tape. After removing the release liner, the second strip was laminated to the test panel, perpendicular to the Cu foil tape strips, such that, it made contact with the second Cu foil strip and then overlapped the first strip of the conductive single sided tape. A 2 kg rubber roll was rolled across the second strip of conductive single sided tape, producing a test panel, FIG. 5. FIG. 5 shows test panel 500 with plastic plate 510, strips of Cu foil tape 520 applied to its surface, first electrically conductive, single-sided tape strip 530 and second electrically conductive, single-sided tape strip 540. After 20 minutes of dwell time, the D.C. electrical resistance between the copper foil strips was measured using a Keithley 580 micro-ohmmeter by placing the ohmmeter leads in contact with the exposed surface of the Cu foil tape strips on either side of the plate. The electrical resistance was recorded 30 seconds after the leads of the micro-ohmmeter contacted the Cu foil tape strips of the test panel.

### Example 1

A conductive polymeric film was prepared by mixing, on a weight basis, 50 parts thermoplastic polyester resin having a number average molecular weight of about 28,000 g/mol and a softening point of about 105° C. dispersed in an organic solvent (available under the trade designation SKYBON ES300 from SK Chemicals, Seongnam-si, Gyeonggi-do, Korea); 50 parts thermoplastic polyester resin having a number average molecular weight of about 21,000 g/mol and a softening point of about 140° C. dispersed in an organic solvent (available under the trade designation SKYBONES 100 from SK Chemicals); 100 parts high purity nickel powder with a fine, three dimensional filamentary (chain-like) structure (available under the trade designation FILAMENTARY NICKLE POWDER TYPE 255 from Novamet Specialty Products Corporation, Wyckoff, N.J.); 50 parts methyl ethyl ketone and 50 parts toluene. The mixture was coated on a conventional silicone release liner using a conventional notch bar coating technique and dried at 100° C. for 1 minute. After drying, the thickness of the conductive polymeric film was about 15 microns.

A conductive adhesive film was prepared as follows. A monomer premix was prepared, on a weight basis, using 75 parts 2-ethylhexyl acrylate, 25 parts N-vinylcaprolactam and 0.04 parts 2,2-dimethoxy-2-phenylacetophenone photoinitiator (available under the trade designation IRGACURE 651 from BASF Corporation, Florham Park, N.J.). This mixture was partially polymerized under a nitrogen-rich atmosphere by exposure to ultraviolet radiation yielding a syrup having a viscosity of about 3,000 cps. On a weight basis, an adhesive precursor solution was prepared from 100 parts of syrup, 0.1 parts additional 2,2-dimethoxy-2-phenylacetophenone photoinitiator, 0.1 parts 1,6-hexanediol diacrylate and 5.4 parts fumed silica (available under the trade designation AEROSIL R 972 from Evonik Industries, Essen, Germany). The components were mixed together using conventional high shear mixing.

The conductive adhesive film was made by passing a conductive, 28 micron thick polyester, nonwoven scrim coated with multiple, thin layers of metal, nickel/copper/nickel, (available under the trade designation PNW-30-PCN from Ajin-Electron Co., Ltd., Busan, Korea) and the adhesive precursor solution between silicone treated transparent release liners through a conventional two roll coater. The gap between the coater rolls was set at about 40 micron. The coated adhesive precursor solution was cured by UV radiation having an intensity of about 3.0 mW/cm² on both the top side and bottom side of the film. Curing on the top and bottom was conducted simultaneously with exposure to UV radiation for about 520 seconds. After curing, the adhesive precursor solution formed a pressure sensitive adhesive within the pores of the nonwoven scrim.

The release liner was removed from one side of the conductive adhesive film and the exposed surface of the conductive adhesive film was laminated to the 15 micron thick conductive polymeric film, yielding an electrically conductive, single-sided tape, Example 1.

Following Electrical Resistance Test Method 1 and Electrical Resistance Test Method 2, the electrical resistance was measured for Example 1 and determined to be 0.35 ohms for Test Method 1 and 5.6 ohms for Test Method 2.

### Example 2

A 15 micron thick conductive polymeric film was prepared as described in Example 1.

A conductive adhesive film, which was pressure sensitive, was prepared as follows. Acrylic copolymer solution, 390 g, 59% solids, (available under the trade designation SEN-7000 from Geomyung Corp., Cheon-an, Korea), 5.85 g of an isocyanate crosslinker solution, 75% solids, (available under the trade designation GT75 from Geomyung Corporation, Cheon-an, Korea), 25 g nickel particle having a particle size of about 4 microns (available under the trade designation T123 Nickel Powder from Vale Canada Limited., Toronto, Canada) and 150 g toluene were mixed together using conventional high shear mixing, forming an adhesive precursor solution. The adhesive precursor solution was then coated on a silicone treated paper liner by a conventional notch bar coating method and dried by passing through an oven at 80° C. for 1 minute. The coated adhesive material with conductive particles was then laminated to one side of a 27 micron thick, conductive mesh (available under the trade designation SUI-2790YCL from Seiren, Osaka, Japan), by pressing between a pair of laminating rolls, followed by winding the conductive mesh/adhesive into a roll. The roll of conductive adhesive film was then annealed at 50° for 2 days to further embed the thin conductive mesh into the adhesive material.

After annealing, the release liner was removed from one side of the conductive adhesive film and the exposed surface of the conductive adhesive film was laminated to the 15 micron thick conductive polymeric film, yielding an electrically conductive, single-sided tape, Example 2.

Following Electrical Resistance Test Method land Electrical Resistance Test Method 2, the electrical resistance was measured for Example 2 and determined to be 0.25 ohms for Test Method 1 and 6.4 ohms for Test Method 2.

Although the present invention has been described with reference to preferred embodiments, workers skilled in the art will recognize that changes may be made in form and detail without departing from the spirit and scope of the invention.

1. An electrically conductive, single-sided tape comprising:
a conductive adhesive layer comprising:
a conductive porous substrate having a plurality of passageways; and
an adhesive material positioned within at least a portion of the passageways; and
a conductive polymeric layer positioned adjacent the conductive adhesive layer.

2. The electrically conductive, single-sided tape of claim 1, wherein the adhesive material is a conductive adhesive material.

3. The conductive single-sided tape of claim 2, wherein the conductive adhesive material comprises metal particles.

4. The conductive single-sided tape of claim 3, wherein the metal particles comprise at least one of: nickel, copper, tin, aluminum, silver, silver coated copper, silver coated nickel, silver coated aluminum, silver coated tin, silver coated gold, silver coated graphite, silver coated glass, silver coated ceramics, silver coated plastics, silver coated silica, silver coated elastomers, silver coated mica, nickel coated copper, nickel coated silver, nickel coated graphite, nickel coated glass, nickel coated ceramics, nickel coated plastics, nickel coated silica, nickel coated elastomers, nickel coated mica, and combinations thereof.

5. The electrically conductive, single-sided tape of claim 1 wherein the conductive porous substrate is a conductive nonwoven substrate.

6. The electrically conductive, single-sided tape of claim 1 wherein the conductive porous substrate comprises conductive fibers.

7. The electrically conductive, single-sided tape of claim 6, wherein a portion of the conductive fibers protrude from at least one major surface of the conductive adhesive layer.

8. The electrically conductive, single-sided tape of claim 6, wherein a portion of the conductive fibers protrude from both major surfaces of the conductive adhesive layer.

9. The conductive single-sided tape of claim 1, further comprising a polymeric film positioned adjacent the conductive polymeric layer.

10. The conductive single-sided tape of claim 1, further comprising a release liner positioned adjacent the conductive adhesive layer.

11. The conductive single-sided tape of claim 1, wherein the conductive single-sided tape is between about 15 μm and about 150 μm thick.

12. The conductive single-sided tape of claim 1, wherein the conductive porous substrate includes a conductive coating.

13. The conductive single-sided tape of claim 1, wherein the adhesive material is a pressure sensitive adhesive material.

14. The conductive single-sided tape of claim 1, wherein the adhesive material is an UV or thermally B-stageable adhesive material.

15. The conductive single-sided tape of claim 1, further comprising a filler selected from the group consisting of: a heat conductive filler, a flame resistant filler, an anti-static agent, a foaming agent, polymeric microspheres and viscosity modifiers.

16. The conductive, single-sided tape of claim 1, wherein the adhesive layer comprises a first adhesive layer and a second adhesive layer.

17. The conductive, single-sided tape of claim 16, wherein the first adhesive layer comprises one metal particle type.

18. The conductive, single-sided tape of claim 16, wherein the second adhesive layer comprises at least two metal particles types.

19. The conductive, single-sided tape of claim 1, wherein the passageways are filled with adhesive material such that the conductive porous substrate includes less than about 10% voids by volume.

20. The conductive, single-sided tape of claim 1, wherein the passageways are filled with adhesive material such that the conductive porous substrate includes less than about 2% voids by volume.
